(19) United States
(12) Patent Application Publication
(10) Pub. No.: US 2025/0257796 A1
(43) Pub. Date: Aug. 14, 2025

(54) MECHANICAL SYSTEM PROVIDED WITH MOVING MECHANICAL ELEMENTS, A MAGNETIC PLUG AND A LUBRICATION SYSTEM PROVIDED WITH MECHANICAL AND MAGNETIC FILTERS

(71) Applicant: AIRBUS HELICOPTERS, Marignane Cedex (FR)

(72) Inventor: Damien GOUJET, Marignane Cedex (FR)

(73) Assignee: AIRBUS HELICOPTERS, Marignane Cedex (FR)

(21) Appl. No.: 18/949,233

(22) Filed: Nov. 15, 2024

(30) Foreign Application Priority Data
Feb. 13, 2024 (FR) 2401391

(51) Int. Cl. F16H 57/04; F16H 61/12

(52) U.S. Cl. CPC F16H 57/0404; F16H 61/12; F16H 2061/1216

(57) ABSTRACT

A mechanical system comprising moving mechanical elements to be lubricated or cooled in a housing, the mechanical system having a lubrication system provided with a tank containing a lubricating fluid, the lubrication system having a main fluid circuit extending from the tank to a fluid spray circuit, the main fluid circuit having a flow generator, a mechanical filter and a magnetic plug. The main fluid circuit comprises a magnetic filter through which the lubricating fluid passes between the tank and the fluid spray circuit, the magnetic filter comprising at least one magnetized wall.

### CROSS REFERENCE TO RELATED APPLICATION

This application claims the benefit of FR 24 01391 filed on Feb. 13, 2024, the disclosure of which is incorporated in its entirety by reference herein.

### TECHNICAL FIELD

The present disclosure relates to a mechanical system provided with moving mechanical elements, a magnetic plug and a lubrication system provided with mechanical and magnetic filters.

### BACKGROUND

A mechanical system may comprise moving mechanical elements to be cooled or lubricated, such as shafts, bearings, mechanical elements for transmitting power or for reducing or increasing the rotational speed, pinions, wheels, splines, etc.

For example, a rotary-wing aircraft may comprise a rotor that helps to provide lift for the aircraft at least in part. To rotate a rotor of this kind, a gearbox-type mechanical system can mechanically connect one or more motors and the rotor. A gearbox of this kind comprises mechanical elements to be lubricated or cooled.

A mechanical system of this kind then comprises a lubrication system for conveying a lubricating fluid to mechanical elements in order to lubricate and/or cool them. Mechanical elements of this kind are referred to hereinafter as “mechanical elements to be lubricated or cooled”.

A known lubrication system comprises a main fluid circuit. This main fluid circuit comprises a lubricating fluid held in a tank. The tank is formed, for example, by the bottom of a housing of the mechanical system to be lubricated or cooled. Moreover, the fluid circuit is provided with a pump that draws fluid from the tank. The pump then moves the fluid to at least one fluid spray circuit, that is sometimes referred to as a “lubrication manifold” or a “fluid spray manifold”. The fluid is then expelled out of the fluid spray circuit in order to reach the mechanical elements to be lubricated or cooled before returning to the bottom of the housing under the effect of gravity.

In addition, the main fluid circuit comprises a cooler. The term “cooler” denotes a device capable of lowering the temperature of a fluid, as opposed to a heater.

In addition, the lubricating fluid may be contaminated with metal magnetic contaminants. Therefore, the mechanical system may comprise mechanical filtration means to prevent large contaminants, for example measuring approximately 10 micrometers or more, from blocking in particular the fluid spray circuit and to ensure the reliability of the mechanical contacts.

Thus, strainers may be arranged upstream of the pump and/or of the fluid spray circuit. The main fluid circuit may also comprise a cartridge filter upstream of the fluid spray circuit. A cartridge filter of this kind comprises a vessel housing a porous filtration cartridge. The fluid enters the vessel and passes through the casing, then exits the filter.

As a result, any particles having dimensions greater than the openings in the casing are trapped in the vessel.

Optionally, the lubrication system comprises only the main fluid circuit or further comprises a back-up fluid circuit. In this case, the main fluid circuit and the back-up fluid circuit can both be configured to draw a lubricating fluid from the same tank and to convey that fluid to one and the same fluid spray circuit or to separate fluid spray circuits. The purpose of the back-up fluid circuit is to allow the mechanical system to operate at least for a predetermined time period in the event of failure of the main fluid circuit. The back-up fluid circuit may extend only in the mechanical system housing to prevent leakage outside the mechanical system.

Furthermore, during operation, the mechanical system may generate metal magnetic particles as a result of at least one of said rotating mechanical elements degrading, for example owing to chipping of the teeth of a pinion or a toothed wheel. These metal magnetic particles, that are indicative of a malfunction, are large, measuring approximately a tenth of a millimeter.

For abnormal operation of the mechanical system to be detected, the mechanical system conventionally comprises a removable magnetic plug for isolating, immobilizing and removing the metal magnetic particles resulting from abnormal operation that fall into the tank. The magnetic plug may be connected to a warning system in order to generate an alert when a particular amount of metal is captured. A magnetic plug is conventionally found at the bottom of the tank and captures the metal magnetic particles falling towards the bottom of the tank. The fluid circuit(s) can draw the lubricating fluid from the tank via a strainer so as not to suck in these metal magnetic particles.

Furthermore, the lubricating fluid may be contaminated with a very fine metal magnetic powder. The metal magnetic powder comprises metal magnetic particles measuring approximately 0.5 to 3 micrometers and/or less than the perforations in the aforementioned strainer, suspended in the lubricating fluid. This metal magnetic powder may result from the manufacture and/or assembly of the mechanical system, for example by shrink-fitting and/or clamping, or from the normal friction of the contact zones between the various moving mechanical elements of the system. The metal magnetic powder has no impact on the operation of either the mechanical system or its lubrication system as the powder is expected to be produced as a result of normal operation, and also because of the very small dimensions of the constituent particles.

Hereinafter, the term “metal particle” is used for large metal magnetic contaminants resulting from a malfunction or from manufacture-induced or assembly-induced contamination; it covers, for example, any metal magnetic particle wherein the space between two distinct points of that particle is greater than 10 micrometers. Conversely, the expression “metal powder” refers to any metal magnetic contaminant resulting from the manufacture, assembly or normal expected wear of the mechanical system (e.g. lapping, fretting); it covers, for example, any contaminant wherein the space between two distinct peripheral points is less than or equal to 10 micrometers. Moreover, “metal powder” can be generated with or without “metal particles” during a malfunction.

When metal powder is present, the mechanical system can continue to be used until its next maintenance, whereas premature maintenance action is taken when a certain quantity of metal particles is present.

However, certain regulations require smaller volumes of metal particles to be detected within a shorter period of time. To comply with these regulations, a magnetic plug having high magnetic pull may be used.

Although effective at sensing large metal particles that fall into the tank, a magnetic plug of this kind also attracts the metal powder suspended in the lubricating fluid in the tank. Therefore, it is possible that the metal powder causes the magnetic plug to quickly sense a large amount of material even though this is just due to normal wear. The flow of the fluid in the lubrication system tends to cause the metal powder to also flow, that gradually adheres to the magnetic plug. Therefore, a magnetic plug having high magnetic pull can generate false alarms causing undue and expensive maintenance actions. The advantage of a magnetic plug of this kind is that any chipping can be detected and an alert generated accordingly, but the disadvantage is that a potential false alert is generated in the medium term due to the plug capturing the metal powder passing in its vicinity. Moreover, the presence of the metal powder resulting from normal operation may delay the capture of metal particles resulting from a malfunction.

Document FR 3 083 283 B1 describes a mechanical system having in particular a magnetic plug in a tank, as well as a magnet in a lubrication system. This magnetic plug and magnet form sensing devices aimed at sensing metal particles passing in their vicinity. Metals attracted by the magnet are swept away by the lubricating fluid when the lubrication system is active. So, this document provides for the arrangement of a bypass duct.

Document FR 3 100 614 B1 discloses a mechanical system having in particular magnetic plugs in a tank and a particle counter.

Document U.S. Pat. No. 5,089,129 A discloses an apparatus provided with a magnetic filter and a porous filter.

Document CN 103452619 A discloses an automobile engine provided with a magnetic drain plug.

Document CN 208237061 U discloses an automobile transmission system provided with a magnetic drain plug.

### SUMMARY

An object of the present disclosure is therefore to propose a mechanical system provided with a lubrication system that aims to limit the number of false alarms generated using a magnetic plug.

The present disclosure relates to a mechanical system comprising moving mechanical elements to be lubricated or cooled in a housing, the mechanical system having a lubrication system provided with a tank containing a lubricating fluid, the lubrication system having a main fluid circuit extending from the tank to a fluid spray circuit, the main fluid circuit having a flow generator and a mechanical filter provided with a cartridge having a porous casing, the lubrication system comprising at least one magnetic plug.

The magnetic plug(s) is/are in contact with the lubricating fluid at least during operation. Thus, a magnetic plug may be arranged, for example, in the tank or on a return path travelled by the lubricating fluid between an element to be lubricated or cooled and the tank. At least one magnetic plug may be outside the main fluid circuit.

For example, a porous casing of this kind of a mechanical filter may comprise a perforated wall, optionally folded in the manner of an accordion so as to have a maximized filtration surface area.

In addition, the lubrication system may also comprise at least one secondary fluid circuit. For example, a secondary fluid circuit may form a conventional back-up circuit that is partially or entirely housed in the housing and/or draws the lubricating fluid from the same tank as the main fluid circuit.

In addition, the main fluid circuit comprises a magnetic filter through which the lubricating fluid passes between the tank and the fluid spray circuit, the magnetic filter comprising at least one magnetized wall.

Therefore, this mechanical system runs counter to pre-conceived notions in that a magnetic filter is provided in addition to a mechanical cartridge filter. In a contradictory manner, the role of the magnetic plug is precisely to capture the metal magnetic contaminants that are present in the lubricating fluid after the elements to be lubricated or cooled have been sprayed, so as to determine the occurrence of any malfunction. At first sight, therefore, it would appear to be counterproductive to filter the metal contaminants present in the lubricating fluid.

However, in an innovative way, it has been noted that false alarms result from the presence of a powerful magnetic plug. This magnetic plug effectively captures metal magnetic contaminants present in the tank, including over time the very fine metal powder resulting from manufacture and normal operation. The metal powder sensed by the magnetic plug can thus generate a false alarm.

The disclosure also comprises a magnetic plug having high magnetic pull. When there is no malfunction, the lubricating fluid flows within the mechanical system and thus passes through the magnetic filter. Metal contaminants are attracted to the magnetized wall of this magnetic filter.

At this stage, the contaminants result merely from the normal operation of the mechanical system. Consequently, the quantity of metal powder likely to be attracted by the magnetic plug is reduced, and so too are the risks of a false alarm being generated. In turn, the mechanical filter can in particular filter other types of contaminants while being less encumbered by the metal contaminants compared with a conventional system. The lubricating fluid is thus effectively decontaminated.

When an element of the mechanical system undergoes a chipping-like malfunction, large metal particles fall towards the tank, under the effect of gravity for example, and are captured by the magnetic plug. This magnetic plug is always placed upstream of both the mechanical filter and the magnetic filter in relation to the movement direction of the lubricating fluid from the tank to the fluid spray circuit, so as to limit the risk of losing metal particles in these filters.

Consequently, this mechanical system associates a magnetic filter with a mechanical filter within the main fluid circuit to at least limit the number of false alarms issued by the magnetic plug. This may potentially reduce downtime costs and operating costs of the mechanical system.

The mechanical system may further comprise one or more of the following features, taken individually or in combination.

According to one possibility, the main fluid circuit may comprise a filtration strainer upstream of the magnetic filter or of the flow generator.

The terms “upstream” and “downstream” are to be considered in relation to the fluid flow direction.

For example, the filtration strainer is arranged in the tank or at an inlet of the main fluid circuit.

According to one possibility compatible with the preceding possibilities, the magnetic plug may be connected to a warning system.

The magnetic plug may generate a signal transmitted to the warning system. For example, the magnetic plug may then close an electrical circuit that electrically powers a warning system.

According to one possibility compatible with the preceding possibilities, the magnetic filter may comprise a retarder that reduces a movement speed of the lubricating fluid within the magnetic filter with respect to a movement speed reached at the inlet of the magnetic filter.

The main fluid circuit tends to move the lubricating fluid at a high flow rate (for example greater than 800 l/h), that may seem favorable for decontaminating this lubricating fluid. However, at such a flow rate, only metal magnetic contaminants passing in the vicinity of the magnetized wall can be attracted and adhere to this magnetized wall. The speed retarder makes it possible to slow down the lubricating fluid in the magnetic filter in order to increase the chances of metal contaminants being attracted to the magnetized wall.

According to one possibility compatible with the preceding possibilities, the magnetic filter may comprise an external vessel and a tube, that is arranged at least partly in the external vessel, an external volume being included between the external vessel and the tube, an internal volume being defined by the tube and being in communication with the external volume, the main fluid circuit comprising an upstream hydraulic connection from the tank to an inlet of the magnetic filter, said inlet being hydraulically connected to an inlet volume formed by the external volume or the internal volume, the main fluid circuit comprising a downstream hydraulic connection hydraulically connecting the internal volume or the external volume, whichever does not form the inlet volume, to the fluid spray circuit, the magnetized wall comprising the external vessel or the tube.

Optionally, said inlet has an inlet passage surface through which the lubricating fluid passes, and the external volume has an external passage surface having an area greater than an area of the inlet passage surface in order to form the aforementioned retarder.

This solution also has the advantage of being able to increase the magnetic surface area and therefore support the capture of metal magnetic contaminants.

According to one possibility compatible with the preceding possibilities, the tube may be a circular cylinder.

According to one possibility compatible with the preceding possibilities, the tube may comprise at least one open intermediate passage surface that places the external volume and the internal volume in communication.

According to a first alternative embodiment of the magnetized wall, the magnetized wall may comprise a wall made of aluminum alloy or plastics material, the magnetized wall comprising a support that is attached to said aluminum alloy or plastics wall and provided with at least one permanent magnet.

For example, a support of this kind is in the form of a sock, made of plastics material or the like, positioned on the aluminum or plastics wall, said sock bearing at least one magnet.

The aluminum alloy has the advantage of being permeable to magnetic waves, that can enhance the attraction of the metal contaminants.

Alternatively, the wall may be made of plastics material.

Using a support that bears one or more magnets around a substantially non-magnetic wall makes it easy to recover the metal magnetic contaminants collected. When an operator removes the magnetic support, the metal magnetic contaminants are no longer attracted by a magnetic force and fall down, making them easy to collect. This arrangement allows the magnetic action on the metal magnetic contaminants to be temporarily suppressed.

According to a second alternative embodiment of the magnetized wall, the magnetized wall may comprise a metal wall contiguous with at least one permanent magnet, or comprise a hollow magnetized bar.

This second alternative has the advantage of having a large magnetized surface and a beneficial efficiency/mass ratio.

According to another aspect, since the main fluid circuit may comprise an upstream hydraulic connection from the tank to an inlet of the magnetic filter, the upstream hydraulic connection may comprise said flow generator, the downstream hydraulic connection comprising at least one of the following apparatuses: a heater, a cooler, the mechanical filter.

The flow generator may be located inside or outside the mechanical system.

The magnetic filter may then be downstream of the flow generator. The magnetic filter may be upstream of a heater, a cooler and/or the mechanical filter in order to limit the quantity of contaminants conveyed to these components and to additionally collect particles for them to be characterized and quantified in the event of a malfunction before they are lost in the mechanical filter and/or the cooler and/or the heater.

According to another aspect, and when there is a magnetic filter having an external vessel and a tube, regardless of how the magnetized wall is obtained, the tube may, according to a first variant, comprise the magnetized wall.

For example, the tube may be magnetized instead of the external vessel to optimize the mass of the system.

According to a second variant, the external vessel may comprise the magnetized wall.

Optionally, the magnetic filter and the mechanical filter may form the same filter, said magnetized wall comprising the external vessel, the tube comprising the porous casing.

The same apparatus then acts as the magnetic filter and the mechanical filter. In addition, by retrofitting the same porous casing on an existing system, the filter can generate the same head loss as before.

According to one possibility, it is possible to arrange at least one magnet or magnetized sock on the external vessel of an existing mechanical filter to obtain a magnetized wall.

According to another aspect, the magnetic filter may be arranged outside said housing.

An arrangement of this kind makes it easy to disassemble the magnetic filter if necessary. The contents of the magnetic filter can be collected and analyzed to perform health diagnostics on the mechanical system.

According to another aspect, the mechanical system may be a gearbox. In addition to a mechanical system, the disclosure relates to an aircraft comprising a mechanical system of this kind.

For example, the mechanical system is a gearbox connected by a mechanical chain to at least one rotary wing in order to rotate it.

In addition to a mechanical system, the disclosure relates to a method for reducing the number of false alarms within a mechanical system comprising moving mechanical elements to be lubricated or cooled in a housing, the mechanical system having a lubrication system provided with a tank containing a lubricating fluid, the lubrication system having a main fluid circuit extending from the tank to a fluid spray circuit, the main fluid circuit having a flow generator and a mechanical filter having a cartridge provided with a porous casing, the lubrication system including at least one magnetic plug. The magnetic plug may be in contact with the lubricating fluid at least during operation, possibly outside the main fluid circuit, for example in the tank or on a return path travelled by the lubricating fluid from an element to be lubricated or cooled to the tank.

The method includes the following steps:
causing the lubricating fluid to flow in the main fluid circuit, the lubricating fluid exiting through the fluid spray circuit and returning to the tank;
decontaminating the lubricating fluid flowing in the main fluid circuit using a magnetic filter and the mechanical filter, the magnetic filter comprising at least one magnetized wall and optionally a retarder that reduces a movement speed of the lubricating fluid; and
generating an alert by means of the magnetic plug when metal is captured by this magnetic plug.

Said minimum quantity can be established by tests or is derived, for example, from a regulation to be complied with, such as the “Certification specification for large helicopters CS-29”.

### BRIEF DESCRIPTION OF THE DRAWINGS

The disclosure and its advantages will become apparent in greater detail from the following description of examples given by way of illustration with reference to the accompanying drawings, wherein:

FIG. 1 is a diagram showing a mechanical system according to the disclosure and the associated method;

FIG. 2 shows an example of a magnetized wall provided with a metal tube and at least one magnet;

FIG. 3 shows an example of a magnetic filter;

FIG. 4 shows an example of a magnetic filter;

FIG. 5 shows an example of a magnetic filter;

FIG. 6 shows an example of a magnetic filter; and

FIG. 7 is a diagram showing a filtration unit comprising a mechanical filter and a magnetic filter.

### DETAILED DESCRIPTION

Elements present in more than one of the figures are given the same reference numerals in each of them.

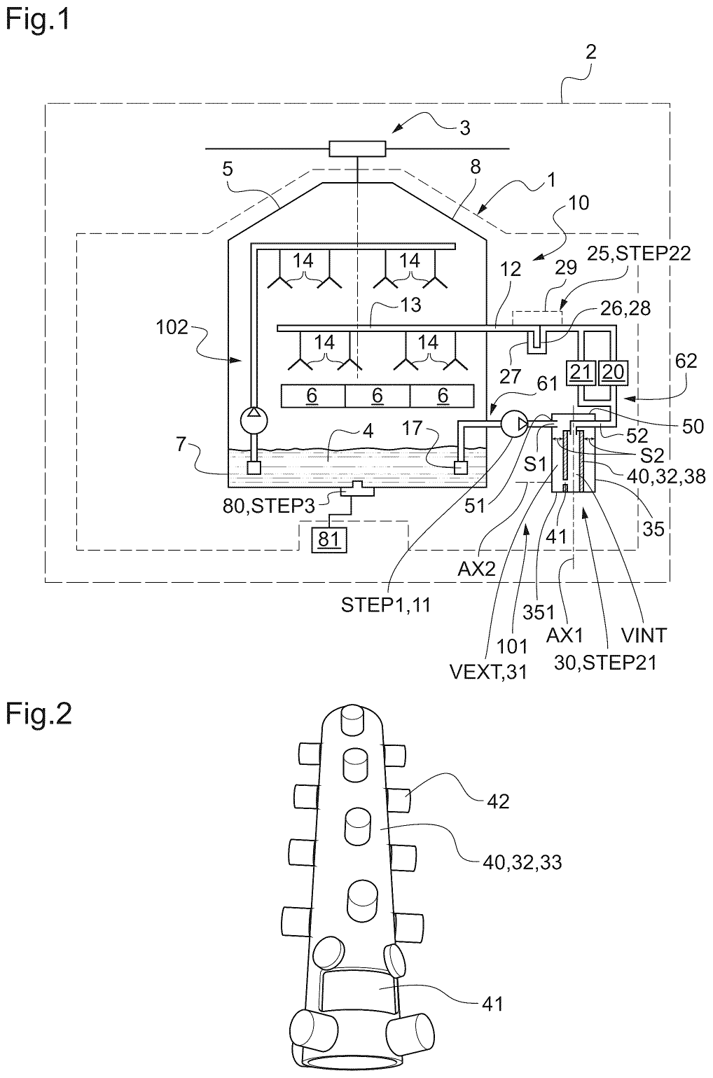

FIG. 1 shows a mechanical system 1 according to the disclosure. This mechanical system 1 may be arranged within various structures and, for example, within a vehicle and possibly within an aircraft 2 according to the example shown. The mechanical system 1 may be a gearbox 8.

For example, the mechanical system 1 is arranged within an aircraft 2 to rotate in particular a rotor 3, possibly by means of an output rotor mast. A rotor 3 of this kind may be a main rotor of a helicopter, a rotor helping to control the yaw movement, a propeller, etc.

Regardless of the nature of the mechanical system 1 and its arrangement, this mechanical system 1 comprises moving mechanical elements 6 to be lubricated or cooled. These mechanical elements 6 to be lubricated or cooled may comprise elements that are moving or rotating relative to a housing 5. Each mechanical element 6 to be lubricated or cooled may comprise, for example, a shaft, a ball bearing mechanism or the like, a power transmission element, an element for reducing or increasing the rotational speed, a pinion, a wheel, a splined component, etc.

The mechanical elements 6 are arranged in an internal volume defined by the housing 5. This housing 5 may comprise a plurality of sub-assemblies that jointly define a chamber wherein the mechanical element(s) 6 to be lubricated or cooled are arranged.

The mechanical system 1 also comprises a lubrication system 10. This lubrication system 10 has a tank 7 holding a lubricating fluid 4. For example, a sub-assembly forming a bottom of the housing 5 forms at least a part of the tank 7. The lubricating fluid 4 may be a lubricating liquid, such as a liquid comprising oil, or any other liquid capable of lubricating and/or cooling a mechanical element 6.

The lubrication system 10 comprises one or more magnetic plugs 80, possibly such as a conventional magnetic plug. The magnetic plug 80 is in contact with the lubricating fluid 4 in the tank 7 according to the example shown. Alternatively, the magnetic plug 80 may be located on a path travelled by the lubricating fluid, for example between a mechanical element 6 to be lubricated or cooled and the tank 7. By way of example, the magnetic plug 80 is attached to the bottom of the tank 7. The magnetic plug 80 may comprise a receiver part in contact with the lubricating fluid 4, and at least one magnetic attraction means in order to capture metal magnetic contaminants, in particular metal particles resulting from chipping of the mechanical elements 6. An attraction means of this kind may comprise a permanent magnet.

For example, the magnetic plug may be of the type in patent EP 3627032.

In the conventional manner, the magnetic plug 80 may be connected to a warning system 81. A warning system 81 of this kind can generate a visual alarm, for example by emitting a light using a light-emitting diode or the like or displaying one or more characters on a screen, or an audible alarm via a loudspeaker, and/or a haptic alarm, for example by means of a vibrating unit that causes a component held or worn by an individual to vibrate.

To move the lubricating fluid 4 towards the mechanical elements 6, the lubrication system 10 comprises a main fluid circuit 101 and even, in addition, at least one secondary fluid circuit 102 such as a back-up circuit, for example.

To direct the lubricating fluid 4 towards the mechanical elements 6 to be lubricated or cooled, the main fluid circuit 101 extends from the tank 7 to a fluid spray circuit 12. The fluid spray circuit 12 may comprise one or more pipelines 13 opening at at least one means 14 for spraying the lubricating fluid, referred to for simplicity as a “sprinkler”. A sprinkler of this kind may, for example, be a spray nozzle or the like, a simple pipe aperture, a system mixing the lubricating fluid with a gas, etc.

In general, the term “pipeline” used above and hereinafter may represent a single pipe or a plurality of pipes attached to each other.

More precisely, the main fluid circuit 101 comprises a flow generator 11 in order to draw the lubricating fluid from the tank 7. The flow generator 11 may comprise a pump or an ejector in communication with a main suction inlet, that under normal conditions is immersed in the lubricating fluid 4 present in the tank 7.

Downstream of the flow generator 11 and upstream of the fluid spray circuit 12, the main fluid circuit 101 comprises a mechanical filter 25. This mechanical filter 25 is provided with a filtration device having a cartridge 26 provided with a porous casing 28. The porous casing 28 may form a filter wall comprising small perforations, for example measuring approximately 10 to 25 micrometers or less. The cartridge 25 may be arranged in a chamber 27. The lubricating fluid 4 to be filtered enters the filtration device and joins the volume arranged between the chamber 27 and the porous casing 28, passes through this porous casing 28 and then leaves the filtration device filtered. Optionally, the mechanical filter 25 comprises a bypass duct 29 for bypassing the filtration device, for example when this filtration device is blocked.

Optionally, the main fluid circuit 101 may comprise a heater 20 and/or a cooler 21. According to one example, a cooler 21 may comprise a heat exchanger. A heat exchanger of this kind may be a radiator or the like swept by air moved by a fan. According to one example, a heater may comprise an electrical resistor.

Furthermore, the main fluid circuit 101 comprises a magnetic filter 30 through which the lubricating fluid 4 passes. This magnetic filter 30 is arranged between the tank 7 and the fluid spray circuit 12. The magnetic filter 30 is then connected to the tank 7 by an upstream hydraulic connection 61 and to the fluid spray circuit 12 by a downstream hydraulic connection 62. Optionally, the main fluid circuit 101 comprises a filtration strainer 17 upstream of the magnetic filter 30. According to one example, the main suction inlet is provided with this filtration strainer 17. The filtration strainer 17 may be of such a size as to filter large contaminants, such as washers or nuts, to protect the flow generator 11, or to filter metal particles resulting from abnormal operation, but it does not filter the metal powder resulting from normal operation. Any metal particle to be filtered may have a distance between two points on its outer surface greater than a threshold, any distance between two points on the outer surface of each particle of the metal powder being less than or equal to that threshold. For example, the threshold is equal to 10 micrometers, the metal particles usually having dimensions of between 0.4 and 1.5 millimeters and the elements of the metal powder usually having dimensions of less than 3 micrometers.

The flow generator 11, the magnetic filter 30, the heater 20, the cooler 21 and/or the mechanical filter 25 may be arranged outside the housing 5.

In addition, the magnetic filter 30 comprises at least one magnetized wall 32 or a retarder 31 that reduces a movement speed of the lubricating fluid 4 within the magnetic filter 30 with respect to a movement speed reached at the inlet of the magnetic filter 30.

For example, the magnetic filter 30 comprises an external vessel 35 and a tube 40, that is optionally at least partly arranged in the external vessel 35, as well as an inlet coupling 51 forming an inlet connected to the upstream hydraulic connection 61 and an outlet coupling 52 forming an outlet connected to the downstream hydraulic connection 62.

For example, the external vessel 35 and the tube 40 may be connected to a cover 50 that comprises the inlet coupling 51 and the outlet coupling 52.

The lubricating fluid 4 thus enters the magnetic filter 30 through an inlet passage surface S1 of the inlet. According to the example shown, the inlet passage surface S1 is to be considered in a plane perpendicular to the movement direction of the lubricating fluid 4. The inlet passage surface S1 may represent the smallest passage surface obtained by cutting the inlet coupling 51 with a plane.

The magnetic filter 30 comprises an inlet volume hydraulically connected to the inlet passage surface S1. This inlet volume may be an external volume VEXT included between the external vessel 35 and the tube 40 or the internal volume VINT defined by the tube 40. The external volume VEXT or the internal volume VINT, whichever does not form the inlet volume, is hydraulically connected to the outlet coupling 52.

Therefore, according to the example in FIG. 1, the upstream hydraulic connection 61 hydraulically connects the tank 7 to the external volume VEXT, possibly via the cover 50, and the downstream hydraulic connection 62 hydraulically connects the internal volume VINT to the fluid spray circuit 12, possibly via the cover 50.

The fluid speed retarder 31 may be formed by an enlarged passage surface. Thus, the external volume VEXT may comprise an external passage surface S2 having an area greater than the area of the inlet passage surface S1. According to the example shown, the external passage surface S2 is to be considered in a plane perpendicular to the movement direction of the lubricating fluid 4 and to the extension axis AX1. The external passage surface S2 may represent the smallest passage surface obtained by cutting the volume VEXT with a plane.

In addition, the magnetic filter 30 comprises at least one intermediate passage surface 41 that places the external volume VEXT and the internal volume VINT in hydraulic communication. According to the example in FIG. 1, the tube 40 rests on a bottom 351 of the external vessel 35 and extends along an extension axis AX1 from this bottom 351 of the external vessel 35. Each intermediate passage surface 41 can then be traversed by a radial axis AX2 perpendicular to the extension axis AX1, advantageously in the vicinity of the bottom 351 to ensure that the lubricating fluid 4 flows along the entirety of the external vessel 35 and the tube 40.

By way of example, the tube 40 is a circular cylinder. For example, a loop of this cylinder has one or more openings forming one or more intermediate passage surfaces 41.

Furthermore, the magnetic filter 30 has a magnetized wall 32. This magnetized wall 32 comprises the external vessel 35 or the tube 40 according to the embodiment.

According to the example in FIG. 1, the tube 40 forms the magnetized wall 32 in that it comprises a hollow magnetized bar 38. A bar 38 of this kind may comprise one half-cylinder forming a north pole and one half-cylinder forming a south pole. Alternatively, the external vessel 35 may comprise a hollow magnetic bar 38 of this kind.

According to the example in FIG. 2, the magnetized wall 32 comprises a metal wall 33 contiguous with one or more permanent magnets 42, at least one permanent magnet possibly extending in the lubricating fluid. According to FIG. 2, the metal wall 33 forms the tube 40. Alternatively, the magnetized wall 32 forms the external vessel 35.

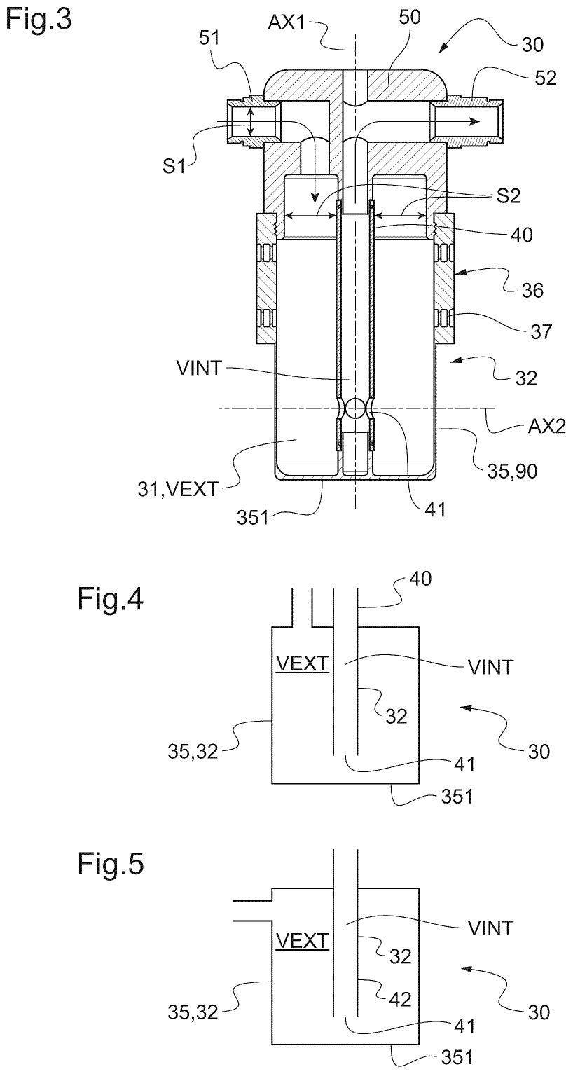

According to the example in FIG. 3, the magnetized wall 32 comprises an aluminum alloy wall 90. Consequently, the magnetized wall 32 comprises a support 36 that is attached to said aluminum alloy wall 90 by screwing, gluing or the like. The support 36 then bears one or more permanent magnets 37. According to FIG. 3, the metal wall 33 forms the external vessel 35. Alternatively, the magnetized wall 32 forms the tube 40.

FIGS. 4 to 6 show various alternative embodiments. In each of the embodiments shown, the external vessel 35 may be connected to the upstream hydraulic connection 61 and the tube 40 is connected to the downstream hydraulic connection 62, or vice versa.

According to the examples in FIGS. 4 and 5, the tube 40 extends into the external vessel 35 without touching the bottom, unlike in the examples in FIGS. 1 and 3. The tube 40 and/or the external vessel 35 may comprise a magnetized wall 32.

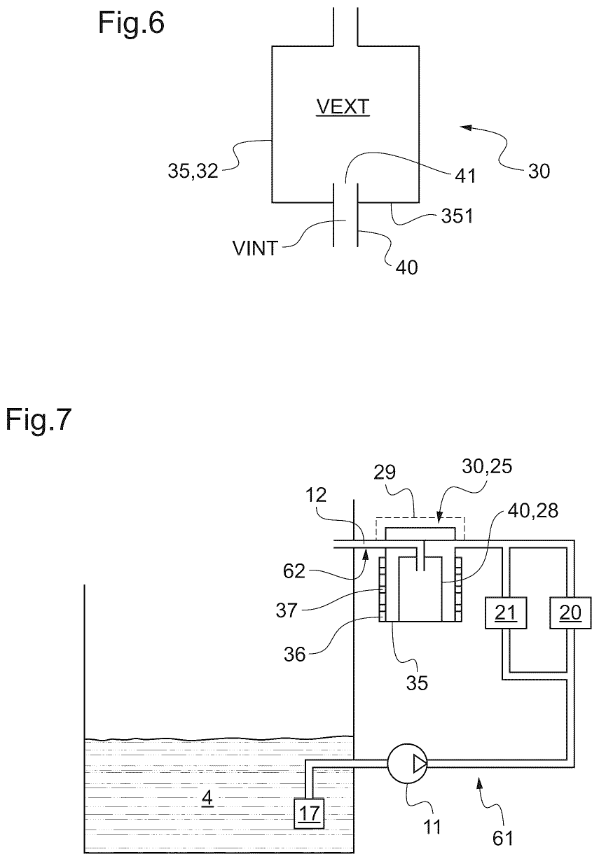

According to the example in FIG. 6, the external vessel 35 comprises a magnetized wall 32.

As shown in FIG. 1 with magnetic filters of these types, the upstream hydraulic connection 61 comprises the flow generator 11, that is connected by pipelines to the magnetic filter 30. The downstream hydraulic connection 62 comprises pipes starting from the magnetic filter 30 and joining the heater 20 and/or the cooler 21, if present, as well as pipelines starting from the heater 20 and/or the cooler 21, if present, and joining the mechanical filter 25.

According to the example in FIG. 7, the magnetic filter 30 and the mechanical filter 25 form one and the same filtration unit.

In this case, the upstream hydraulic connection 61 may, according to one example, comprise the flow generator 11, that is connected by pipelines to the heater 20 and/or the cooler 21, if present, as well as pipelines that leave the heater 20 and/or the cooler 21, if present, and join the external volume of the filtration unit. The downstream hydraulic connection 62 comprises a coupling that connects the filtration unit and the fluid spray circuit 12. An arrangement instead of the magnetic filter of FIG. 1 is also possible.

Furthermore, the magnetized wall 32 comprises the external vessel 35. This external vessel 35 may then comprise a hollow magnetized bar 38, a metal wall contiguous with one or more permanent magnets, or an aluminum alloy wall contiguous with a support bearing one or more permanent magnets.

In addition, the tube 40 comprises the porous casing 28.

The method implemented according to the disclosure is explained below on the basis of the embodiment of FIG. 1, on the understanding that the other embodiments described operate in a similar manner.

This method comprises causing STEP1 the lubricating fluid 4 to flow in the main fluid circuit 101. At the outlet of the main fluid circuit 101, the lubricating fluid 4 is ejected by the fluid spray circuit 12 and returns to the tank 7 under the effect of gravity, for example.

In addition, the method comprises a step of decontaminating STEP21, STEP22 the lubricating fluid 4 flowing in the main fluid circuit 101 using the magnetic filter 30 and the mechanical filter 25.

According to the example in FIG. 1, the lubricating fluid 4 containing the metal powder enters the inlet volume, this inlet volume being formed by the external volume VEXT according to the example. The movement speed of the lubricating fluid 4 is optionally reduced due to the passage surface S2 of the external volume VEXT being greater than the inlet passage surface S1. The magnetized wall 32 attracts this metal powder. Limiting the movement speed of the lubricating fluid 4 also tends to limit the metal powder being pulled off the magnetized wall 31. Optionally, at the end of an operation phase of the mechanical system 1, the magnetic filter 30 can be cleaned, the magnetic filter 30 being able to be cleaned all the more simply when it is located outside the housing 5. The lubricating fluid 4 is also subsequently filtered by the porous casing 28.

Contaminants collected during cleaning can be used to assess the condition of the mechanical system.

Thus, the magnetic filter 30 and mechanical filter 25 allow the lubricating fluid 4 to be decontaminated. The magnetic plug 80 thus senses little magnetic powder.

If a mechanical element 6 degrades, magnetic particles fall into or reach the tank 7. The optional filtration strainer 17 can prevent these magnetic particles from entering the magnetic filter 30 or the main fluid circuit 101. In addition, the magnetic particles are captured by the magnetic plug 80. This magnetic plug 80 can generate a signal transmitted to the warning system 81 to generate an alert STEP3 when a minimum quantity of metal is sensed by this magnetic plug 80.

It goes without saying that the implementation of the present disclosure may be varied in numerous ways. Although several embodiments are described above, it should readily be understood that it is not conceivable to exhaustively identify all possible embodiments. It is of course possible to replace any of the means described with equivalent means without departing from the scope of the present disclosure.

What is claimed is:

1. A mechanical system comprising moving mechanical elements to be lubricated or cooled in a housing, the mechanical system having a lubrication system provided with a tank containing a lubricating fluid, the lubrication system having a main fluid circuit extending from the tank to a fluid spray circuit, the main fluid circuit having a flow generator and a mechanical filter provided with a cartridge having a porous casing, the lubrication system comprising a magnetic plug,
wherein the main fluid circuit comprises a magnetic filter through which the lubricating fluid passes between the tank and the fluid spray circuit, the magnetic filter comprising at least one magnetized wall, the magnetic plug being connected to a warning system for generating an alert when metal is captured by this magnetic plug.

2. The mechanical system according to claim 1,
wherein the magnetic filter comprises a retarder that reduces a movement speed of the lubricating fluid within the magnetic filter with respect to a movement speed reached at the inlet of the magnetic filter.

3. The mechanical system according to claim 1,
wherein the magnetic filter comprises an external vessel and a tube, that is arranged at least partly in the external vessel, an external volume being included between the external vessel and the tube, an internal volume being defined by the tube and being in communication with the external volume, the main fluid circuit comprising an upstream hydraulic connection from the tank to an inlet of the magnetic filter, the inlet being hydraulically connected to an inlet volume formed by the external volume or the internal volume, the main fluid circuit comprising a downstream hydraulic connection hydraulically connecting the internal volume or the external volume, whichever does not form the inlet volume, to the fluid spray circuit, the magnetized wall comprising the external vessel or the tube.

4. The mechanical system according to claim 2,
wherein the magnetic filter comprises an external vessel and a tube, that is arranged at least partly in the external vessel, an external volume being included between the external vessel and the tube, an internal volume being defined by the tube and being in communication with the external volume, the main fluid circuit comprising an upstream hydraulic connection from the tank to an inlet of the magnetic filter, the inlet being hydraulically connected to an inlet volume formed by the external volume or the internal volume, the main fluid circuit comprising a downstream hydraulic connection hydraulically connecting the internal volume or the external volume, whichever does not form the inlet volume, to the fluid spray circuit, the magnetized wall comprising the external vessel or the tube and wherein the inlet has an inlet passage surface through which the lubricating fluid passes, the external volume has an external passage surface having an area greater than an area of the inlet passage surface in order to form the retarder.

5. The mechanical system according to claim 3,
wherein the tube comprises at least one open intermediate passage surface that places the external volume and the internal volume in communication.

6. The mechanical system according to claim 3,
wherein the tube comprises the magnetized wall.

7. The mechanical system according to claim 3,
wherein the magnetic filter and the mechanical filter form the same filter, the magnetized wall comprising the external vessel, the tube comprising the porous casing.

8. The mechanical system according to claim 1,
wherein the magnetized wall comprises a wall made of aluminum alloy or plastics material, the magnetized wall comprising a support that is attached to the aluminum alloy or plastics material wall and provided with at least one permanent magnet.

9. The mechanical system according to claim 1,
wherein the magnetized wall comprises a metal wall contiguous with at least one permanent magnet, or comprises a hollow magnetized bar.

10. The mechanical system according to claim 1,
wherein since the main fluid circuit comprises an upstream hydraulic connection from the tank to an inlet of the magnetic filter, the upstream hydraulic connection comprises the flow generator, the downstream hydraulic connection comprising at least one of the following apparatuses: a heater, a cooler, the mechanical filter.

11. The mechanical system according to claim 1,
wherein the magnetic filter is arranged outside the housing.

12. The mechanical system according to claim 1,
wherein the mechanical system is a gearbox.

13. An aircraft,
wherein the aircraft comprises the mechanical system according to claim 1.

14. A method for reducing the number of false alarms within a mechanical system comprising moving mechanical elements to be lubricated or cooled in a housing, the mechanical system having a lubrication system provided with a tank containing a lubricating fluid, the lubrication system having a main fluid circuit extending from the tank to a fluid spray circuit, the main fluid circuit having a flow generator and a mechanical filter provided with a cartridge having a porous casing, the lubrication system comprising at least one magnetic plug,
wherein the method comprises the following steps:
causing the lubricating fluid to flow in the main fluid circuit, the lubricating fluid exiting through the fluid spray circuit and returning to the tank;
decontaminating the lubricating fluid flowing in the main fluid circuit using a magnetic filter and the mechanical filter; and
generating an alert by means of the magnetic plug when metal is captured by this magnetic plug.
